(19) United States
(12) Patent Application Publication
(10) Pub. No.: US 2006/0240802 A1
(43) Pub. Date: Oct. 26, 2006

(54) METHOD AND APPARATUS FOR GENERATING SESSION KEYS

(75) Inventors: Narayanan Venkitaraman, Schaumburg, IL (US); Madjid F. Nakhjiri, Palatine, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/276,016

(22) Filed: Feb. 9, 2006

Related U.S. Application Data
(60) Provisional application No. 60/674,857, filed on Apr. 26, 2005.

(51) Int. Cl. H04M 1/66; H04Q 7/20

(52) U.S. Cl. 455/411; 455/437

(57) ABSTRACT

Nonce exchange with a target BS is performed even when the MS connected to the source BS so when the mobile reaches the new BS, it will be able to create a fresh key quickly. Alternatively, the MS can provide the nonce directly to the target base station immediately (or very soon) upon handing over. In a similar manner, the mobile will receive the target BS nonce via one of several techniques. In a first embodiment of the present invention the target BS will share the BS nonce with the source BS which will provide the nonce to the MS. In a second embodiment of the present invention the target base station will transmit the nonce over-the-air to the MS as part to the initial exchanges leading to the set up of the wireless link between the MS and the target BS.

### FIELD OF THE INVENTION

The present invention relates generally to wireless communication and in particular, to a method and apparatus for generating session keys in a wireless communication system.

### BACKGROUND OF THE INVENTION

In many wireless communication systems it is necessary for a new session key to be generated when handing over from a source base station (BS) to a target BS. More particularly, when actively communicating with a base station (source base station) it may be desirable to break communications with the source base station and begin communications with a base station better suited to handle the communications (target base station). When a node, or mobile station, hands off from a source BS to a target base station, the mobile needs a new set of keys or else it may be prone to replay and other attacks. For a communication system, such as that employing the IEEE 802.11 system protocol, the existing solution is to derive keys based on fresh value exchange after moving to a new BS. Fresh value can be a time stamp or a random number typically called nonce. Fresh value exchanges result in more delays and increase handoff latency. For this reason future communication systems, such as those utilizing the IEEE 802.16 standard, are staying away from deploying a nonce extension (re-using old keys) and thereby are becoming prone to security attacks. Therefore, a need exists for a method and apparatus for generating post-handover session keys in a way that does not result in excessive delay and handoff latency.

### BRIEF DESCRIPTION OF THE DRAWINGS

FIG. 1 is a block diagram of a communication system.

FIG. 2 is a more-detailed block diagram of the communication system of FIG. 1.

FIG. 3 is a flow chart showing operation of a mobile station of FIG. 2.

FIG. 4 is a flow chart showing operation of the mobile station of FIG. 2 in accordance with an alternate embodiment of the present invention.

FIG. 5 is a flow chart showing operation of the base station of FIG. 2.

FIG. 6 is a flow chart showing operation of the base station of FIG. 2 in accordance with an alternate embodiment of the present invention.

### DETAILED DESCRIPTION OF THE DRAWINGS

In order to address the above-mentioned need, a method and apparatus for generating fresh session keys in a wireless communication system is provided herein. In accordance with the preferred embodiment of the present invention MS fresh value (MSFV) exchange with the target BS is performed even when the MS connected to the source BS. So when the mobile reaches the new BS, it will be able to create a fresh key quickly. Alternatively, the MS can provide the fresh value directly to the target base station immediately (or very soon) upon handing over. In a similar manner, the mobile will receive the target BS fresh value (BSFV) via one of several techniques. In a first embodiment of the present invention the target BS will share the BS fresh value with the source BS which will provide the fresh value to the MS. In a second embodiment of the present invention the target base station will transmit the fresh value over-the-air to the MS as part to the initial exchanges leading to the set up of the wireless link between the MS and the target BS.

In one embodiment in the context of 802.16e based system, The BSFV is a fresh value provided to the MSS by the old serving BS as part of the RNG-RSP (Ranging Response). The MSFV is a fresh value provided to the current serving BS by the MSS during the re-entry in the RNG-REQ (Ranging Request) or BS-HO-REQ/RSP (Base Handover Request or response). Using the MSFV, BSFV and other pre-existing shared secret the required keys and uses these keys as described in the specification. The MS may include the BSFV inside a BSFV TLV and the MSFV inside the MSFV TLV. The old and current serving BSs share the BSFV vi backbone messages such as HO-CONFIRM

By including the whole or part of the fresh value exchange within the initial handover signaling, both the round trip times and the CPU processing time (at a the mobile node) will be removed from the timing critical path of handover and thereby reduce the perceived interruption in traffic data (between traffic down at previous BS and traffic up at target BS) significantly.

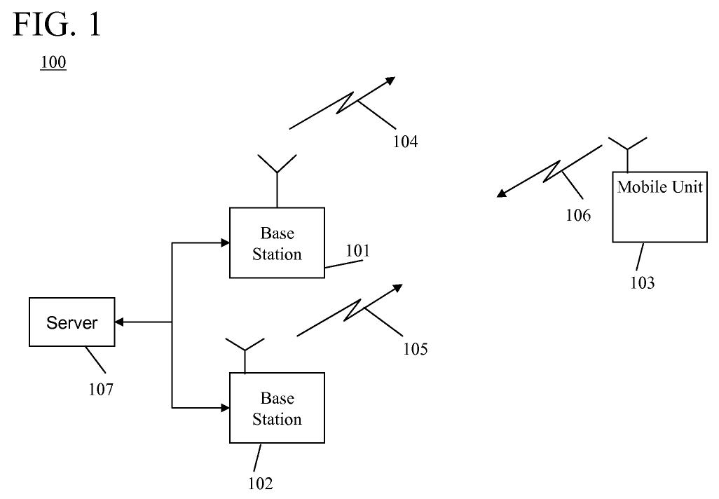

Turning now to the drawings, wherein like numerals designate like components, FIG. 1 is a block diagram of communication system 100. In the preferred embodiment of the present invention, communication system 100 utilizes a communication system protocol as described by the IEEE 802.16 specification. However, in alternate embodiments communication system 100 may utilize other communication system protocols such as, but not limited to, a communication system protocol defined by the IEEE 802.11 standard, a communication system protocol defined by the IEEE 802.15.3 Wireless Personal Area Networks for High Data Rates standard, or the communication system protocol defined by the IEEE 802.15.4 Low Rate Wireless Personal Area Networks standard, . . . , etc.

Communication system 100 includes a number of network elements such as base station 101, base station 102, mobile station 103, and server 107. It is contemplated that network elements within communication system 100 are configured in well known manners with processors, memories, instruction sets, and the like, which function in any suitable manner to perform the function set forth herein.

As shown, mobile station 103 is communicating with base station 101 and 102 via uplink communication signals 106 and base stations 101 and 102 are communicating with mobile station 103 via downlink communication signals 104 and 105, respectively.

During operation, mobile station 103 authenticates with communication system 100 by performing full authentication exchange with a network entity such as an Authentication, Authorization, Accounting server (AAA server 107) or an Extensible Authentication protocol server (EAP server) that is aware of mobile station's rights with respect to network access. Such authentication can be done through a variety of methods and generally involves many roundtrips between the mobile station 103 and the server 107 going through the initial serving base station 101 and for this reason is not be repeated during a handover process.

Original authentication with communication system 100 will result in server 107 providing MS 103 a Pair-wise Master Key (PMK) that may then be utilized to generate temporary session keys used for encryption and authorization. More specifically, each communication session between a base station and a mobile station utilizes a session key for such things as encrypting and providing integrity protection for the exchanged traffic. The session key used for a particular base station is a function of the PMK, a Base Station Identifier, a Mobile station identifier, and two other numbers (fresh values, FV). In other words:
Session key=f(PMK, BSID, MSID, BSFV, MSFV).
The BSFV is generated by the target BS and the MSFV is generated by the mobile station and in the preferred embodiment of the present invention comprise random numbers. In alternate embodiments, however, fresh values may comprise other forms such as, but not limited to time stamps, frame numbers, and nonces.

New session keys need to be generated when a mobile station hands over to another base station. Thus, when a mobile station needs to hand off to a target BTS, the mobile and the base station will have to generate temporary session keys used for data encryption and authentication. However, since the temporary session keys are a function of the two fresh values, the two fresh values need to somehow be provided to the mobile and the target base station in order to generate the temporary session keys. More specifically, for security reasons, the session key is never transmitted between a base station and a mobile station. Instead, the base station and the mobile station each generate the session key independently, and hence, both the base station and the mobile station must be provided with the BSFV and the MSFV.

Providing the Fresh Values from the MS to the Target BTS

In a first embodiment of the present invention an MSFV is generated by the mobile station and provided to the target base station in one of two manners. In first embodiment of the present invention, once handover is needed, the MS will determine the target base station and generate a fresh value. The fresh value will be provided via over-the-air communication (such as over handover indication, HO-IND, message) to the source base station along with the identification of the target base station. The source base station will provide the target base station with the MSFV. This may be done via over-the-air communication, or alternatively via standard network interconnections. For example, a BS backbone signal could transport the fresh value from one BS to another.

In an alternate embodiment of the present invention the MS will determine the target base station and generate a fresh value. The fresh value will be provided via over-the-air communication to the actual target base station over messages such as a range request (RNG_REQ) message.

Providing the Fresh Value from the Target BTS to the MS

Notifying the MS of the BS-generated fresh value may take place in one of ways. In a first embodiment of the present invention, the target BS is notified of the desire for the MS to hand over to it via a handover pre-notification message transmitted to it by the source BS. In response, the target base station provides the source base station with the BSFV. A handoff-request message (e.g., IEEE 802.16 BS-HO_REQ message) is then transmitted to the mobile by the source base station. The handoff-request message directs the mobile to handoff to the target base station. The BSNonce is included as part of the handoff-request message.

Alternatively, in a second embodiment of the present invention, the a fresh value corresponding to multiple target BSs is generated (by source BS or a fresh value generation server) and the MS is notified of the BSFV via the source base station during the initial ranging (ranging is the process of acquiring correct time offset and power adjustment at the mobile station) with the serving base station.

Alternatively, in a third embodiment of the present invention, the MS is directly notified of the BSFV via the target base station. More particularly, the mobile station could do optional ranging (with target BS during scanning and obtain a fresh value in an IEEE 802.16 RNG-RSP message.

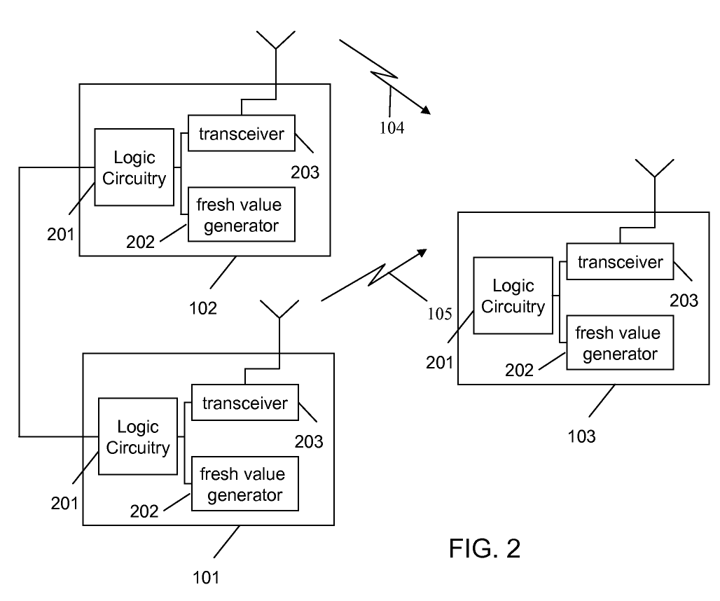

FIG. 2 is a more-detailed block diagram of the communication system of FIG. 1. As shown, base stations 101 and 102 along with mobile station 103 comprise logic circuitry 201, fresh value generator 202, and transceiver 203. Logic circuitry 201 preferably comprises a microprocessor controller, such as, but not limited to a Motorola Motorola HC08 8-bit processor. In the preferred embodiment of the present invention logic circuitry 701 serves as means for controlling transceiver 203, and as means for analyzing message content to determine any actions needed. Additionally transmit/receive circuitry 203 are common circuitry known in the art for communication utilizing a well known communication protocol, and serve as means for transmitting and receiving messages. For example, in the preferred embodiment of the present invention transceivers 203 are well known transmitters that utilize the IEEE 802.16 communication system protocol. Other possible transmitters and receivers include, but are not limited to transceivers utilizing Bluetooth, IEEE 802.11, or HyperLAN protocols.

Fresh value generator 202 is provided for generating fresh values. As discussed in the preferred embodiment of the present invention the fresh value genereartor 202 is a nonce generator that comprises a random-number generator that generates nonces as random numbers. However, in alternate embodiments of the present invention, fresh value generators 202 may generate fresh values in other manners. For example, fresh values may be generated as a previously unrepeated random number, a time stamp comprising a current time, or as a sequence number, such as a current frame number.

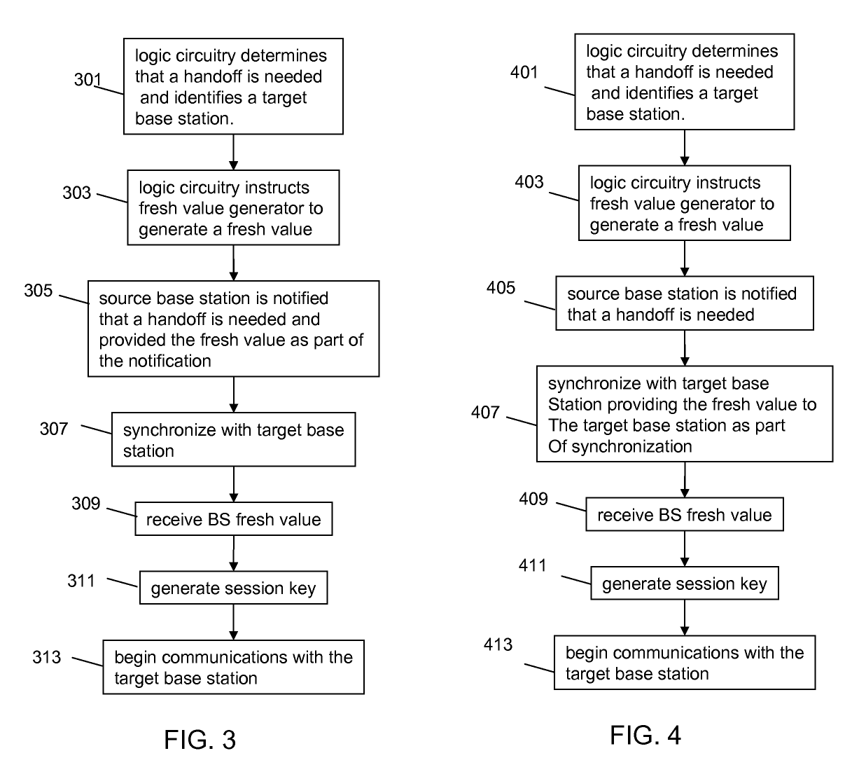

FIG. 3 is a flow chart showing operation of a mobile station of FIG. 2 in accordance with a first embodiment of the present invention. As discussed, in the first embodiment of the present invention mobile station 103 generates a fresh value and provides it to a target base station (e.g., base station 102) via the source base station (e.g., base station 101). The logic flow begins at step 301 where logic circuitry 201 determines that a handoff is needed and identifies a target base station. At step 303 logic circuitry instructs fresh value generator 202 to generate a fresh value. At step 305 the source base station 101 is notified that a handoff is needed. In a communication system employing the IEEE 802.11 communication system protocol, the notification that a handoff is needed is accomplished via sending (via transceiver 203) source base station 101 a HO-IND message. In the first embodiment of the present invention, the HO-IND message contains the MS-generated fresh value which will be provided to target base station 102 by source base station 101. Synchronization is then made with the target base station via ranging and the sending of a range-request message (step 307). The logic flow continues to step 309 where transceiver 203 receives the BSFV and provides this to logic circuitry 201. At step 311 a session key is generated by logic circuitry 201. As discussed, the session key is a function of PMK, BSID, MSID, BSNonce, and MSNonce and is generated by the following formula:
Session key=f(PMK, BSID|MSID|BSFV|MSFV, “Session keys”, session key length).

Finally, at step 313 communications begins with the target base station utilizing the appropriate session key. As discussed, the session key will be utilized by both the MS and the BS for encrypting communications between the two.

FIG. 4 is a flow chart showing operation of the mobile station of FIG. 2 in accordance with an alternate embodiment of the present invention. As discussed, in the alternate embodiment of the present invention mobile station 103 generates a fresh value and provides it to a target base station (e.g., base station 102) via over-the-air communication as part of standard messaging. The logic flow begins at step 401 where logic circuitry 201 determines that a handoff is needed and identifies a target base station. At step 403 logic circuitry instructs fresh value generator 202 to generate a fresh value. At step 405 the source base station 101 is notified that a handoff is needed. In a communication system employing the IEEE 802.11 communication system protocol, the notification that a handoff is needed is accomplished via sending (via transceiver 203) source base station 101 a HO-IND message. Synchronization is then made with the target base station via ranging and the sending of a range-request message (step 407). In the alternate embodiment of the present invention the MS-generated fresh value is provided to the target base station as part of the range-request message. The logic flow continues to step 409 where transceiver 203 receives the BSFV and provides this to logic circuitry 201. At step 411 a session key is generated by logic circuitry 201. Finally, at step 413 communications begins with the target base station utilizing the appropriate session key. As discussed, the session key will be utilized by both the MS and the BS for encrypting communications between the two.

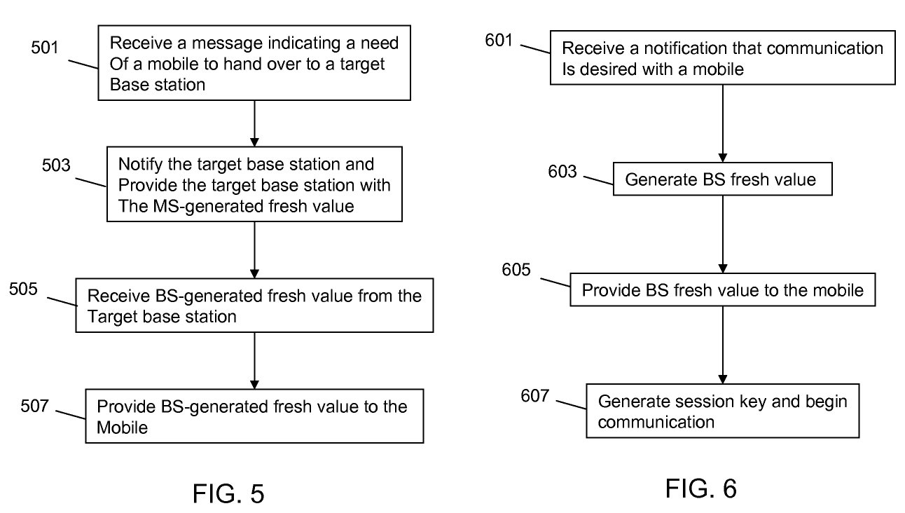

FIG. 5 is a flow chart showing operation of a source base station of FIG. 2 in accordance with a first embodiment of the present invention. As discussed above, the source base station may receive fresh values from both the MS and the target BS. The fresh values will be appropriately routed. The logic flow begins at step 501 where transceiver 203 receives a HO-IND message from a MU indicating the need to hand over to the target base station (e.g., base station 102). As discussed, as part of the HO-IND message a MS-generated fresh value may be included. At step 503, logic circuitry 201 notifies the target base station of the desire to hand over mobile station 103 providing the target base station the MSFV. In response logic circuitry 201 receives a BS-generated fresh value from the target base station (step 505). This is then provided to mobile station 103 via transceiver 205 and downlink communication signal 105 (step 507).

FIG. 6 is a flow chart showing operation of a target base station of FIG. 2. As discussed, the target base station may provide its fresh value to the mobile station through the source base station, or alternatively, the target base station may simply transmit the fresh value directly to the mobile station as part of a ranging process. The logic flow begins at step 601 where logic circuitry 201 receives a notification from a source base station that communication is desired with a particular mobile station (e.g., mobile station 103). As discussed above, the notification may comprise the MSFV. At step 603 the BS fresh value is generated by fresh value generator 202 and at step 605 the BS fresh value is provided to the mobile. As discussed above, in a first embodiment, the BS fresh value is provided to the mobile by sending the BS fresh value to the source base station, which transmits it to the mobile. Alternatively, the BS fresh value may be directly transmitted to the mobile via transceiver 203 and downlink communication signal 104.

Continuing, once the fresh values are appropriately exchanged, the logic flow continues to step 607 where a session key is generated by logic circuitry 201 and the target base station begins communication with the mobile. As discussed above, the session key will be utilized to encrypt communication between the target base station and the mobile.

As discussed above, in the preferred embodiment of the present invention communication system 100 utilizes an IEEE 802.16 system protocol. The following text highlights the changes necessary to the IEEE 802.16 specification in order to implement the above described method of fresh value exchange.

Changes Summary

In section 7.2.2.2.9 Message authentication keys (OMAC/HMAC) and KEK derivation the following changes are made:

MAC (message authentication code) keys are used to sign management messages in order to validate the authenticity of these messages. The MAC to be used is negotiated at SS Basic Capabilities negotiation. There is a different key for UL and DL messages and also a OMAC key for each multicast group (this is DL direction only). A Freshness Value shall be used to when deriving any key from the AK. A BS may also use the value in the RNG-REQ from MSS to protect against replay attacks. The BSFV can be shared between the BSs via backbone messages. Timestamps or freshly generated random numbers may be used as freshness value. An MSS shall retain the most recent freshness value provided to it in the RNG-RSP or BS-HO-REQ/RSP message from the serving BS. In addition the MSS shall include a freshness value as a TLV in its RNG-REQ message. The BS and the MSS shall use these values to derive keys from the AK as described below. During initial network entry, BSFV value shall be set 0 in the RNG-REQ from the MSS

The keys used for OMAC calculation and for KEK are as follows:

OMAC_KEY_U|OMAC_KEY_D|KEK<=Dot16KDF(AK, SSID|BSID|MSFV|BSFV|“OMAC_KEYS+KEK”, 384)

OMAC_KEY_GD<=Dot16KDF(GKEK, “GROUP OMAC KEY”, 128) (Used for group management messages MAC)

The keys used for HMAC calculation and for KEK are as follows:

HMAC_KEY_U|HMAC_KEY_D|KEK<=Dot16KDF(AK, SSID|BSID|MSFV|BSFV|“HMAC_KEYS+KEK”, 448)

HMAC_KEY_GD<=Dot16KDF(GKEK, “GROUP HMAC KEY”, 160) (Used for group management messages MAC)

FIG. 134, add the modified formula for HMAC and OMAC

In section 7.2.2.4.1 AK Context, at the end of paragraph “In HO scenario, if the MS was previously connected to the TBS, the derived AK will be identical to the last one, as long as the PMK stays the same. In order to maintain security in this scenario: the context of the AK must be cached by both sides and to be used from the point it stopped if context lost by one side, re-authentication is needed to establish new PMK and new AK context.” insert:

A BS may skip re-authentication if the MSS includes a valid MSFV and BSFV TLV in the RNG-REQ. If re-authentication is skipped, fresh keys shall be computed by the MSS and BS as described in section 7.2.2.2.9 and the RNG-REQ and RNG-RSP shall be authenticated using the freshly derived HMAC or OMAC keys.

In section 6.3.2.3.5 Ranging request message, at end of section before the paragraph on HMAC tuple, insert:

The following parameter shall be included in the RNG-REQ message when the MS is attempting to perform network entry

MSFV (see 11.16.2)

BSFV (see 11.16.3)

In section 6.3.2.3.6 Ranging response message, at the end of the section insert:

The following TLV parameter shall be included by the BS in response to RNG_REQ from MSS during network initial entry or reentry.

BSFV (see 11.16.3)

MSFV (see 11.16.2)

In section 11.16 Handover management encodings, after 11.16.1 insert the following:

11.16.2 MSFV

This value may be a freshly generated random number or the lowest (16-32) bits in the time value maintained by the MSS and shall be included in the RNG-REQ from MSS during network entry or reentry. A BS may include this in its RNG-RSP as a copy of the value it received from the MSS in the corresponding RNG-REQ

| Type | Length | Value | Scope |
|---|---|---|---|
| 2 | (8-32 bits) | Fresh random number or | RNG-REQ, RNG-R |
| | | current time stamp | |

11.16.3 BSFV

When a BSFV includes this in its RNG-RSP, this value may be a freshly generated random number or the lowest (16-32) bits in the time value. When the MSS includes this in its RNG-REQ, this is the last BSFV received from the BS. During initial entry this value may be skipped. If included, it shall be set to 0.

| Type | Length | Value | Scope |
|---|---|---|---|
| 3 | (8-32 bits) | Freshly generated | RNG-RSP, RNG-R |
| | | random number or | |
| | | time stamp | |

In Section 6.3.2.3.51 BS_HO-REQ message, after HO_authorization_policy_support field, insert:

| | | |
|---|---|---|
| BSFV Indicator | 1 | To indicate a freshness value for key |
| | | computation at target is included |
| | | 0: Freshness value is not included |
| | | 1: Freshness value is included |
| If (BSFV Indicator | — | — |
| == 1) { | | |
| BSFV | 8-32 | A freshly obtained value for the MSS |
| | | corresponding to target BS |
| } | | |

In Section 6.3.2.3.53 BS_HO-RSP message, after HO_authorization_policy_support field, insert:

| | | |
|---|---|---|
| BSFV Indicator | 1 | To indicate a freshness value for AK |
| | | computation at target is included |
| | | 0: Freshness value is not included |
| | | 1: Freshness value is included |
| If (BSFV Indicator | — | — |
| == 1) { | | |
| BSFV | 8-32 | A freshly obtained value for the MSS |
| | | corresponding to target BS |
| } | | |

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for generating a session key, the method comprising the steps of:
generating a first nonce (fresh value);
providing the first nonce to a source base station as part of an indication of a need to hand over to a target base station;
receiving a second nonce generated at the target base station; and
generating the session key based on the first and the second nonce.

2. The method of claim 1 wherein the step of generating the first nonce comprises the step of generating a random number.

3. The method of claim 1 wherein the step of generating the first nonce comprises the step of generating a nonce based on a time stamp, a sequence number, or a current frame number.

4. The method of claim 1 wherein the step of receiving the second nonce comprises the step of receiving the second nonce via an over-the-air communication from the source base station.

5. The method of claim 1 wherein the step of receiving the second nonce comprises the step of receiving the second nonce via an over-the-air communication from the target base station.

6. The method of claim 1 wherein the step of generating the session key comprises the step of generating the session key as a function of a pair-wise master key (PMK), a Base Station Identifier, a Mobile station identifier, the first nonce, and the second nonce.

7. The method of claim 1 further comprising the step of:
encrypting communications with the target base station with the session key.

8. The method of claim 1 wherein the step of providing the first nonce to the source base station causes the source base station to forward the first nonce to the target base station.

9. A method comprising the steps of:
generating a first nonce;
providing the first nonce to a target base station as part of a ranging operation;
receiving a second nonce generated at the target base station; and
generating the session key based on the first and the second nonce.

10. The method of claim 9 wherein the step of generating the first nonce comprises the step of generating a random number.

11. The method of claim 9 wherein the step of generating the first nonce comprises the step of generating a nonce based on a time stamp, a sequence number, or a current frame number.

12. The method of claim 9 wherein the step of receiving the second nonce comprises the step of receiving the second nonce via an over-the-air communication from the source base station.

13. The method of claim 9 wherein the step of receiving the second nonce comprises the step of receiving the second nonce via an over-the-air communication from the target base station.

14. The method of claim 9 wherein the step of generating the session key comprises the step of generating the session key as a function of a pair-wise master key (PMK), a Base Station Identifier, a Mobile station identifier, the first nonce, and the second nonce.

15. The method of claim 9 further comprising the step of:
encrypting communications with the target base station with the session key.

16. A method comprising the steps of:
receiving, at a source base station, notification that a mobile station desires to hand off to a target base station, wherein the notification comprises a first nonce generated at the mobile station;
providing the first nonce (or fresh value) to the target base station;
receiving a second nonce from the target base station; and
providing the second nonce to the mobile station via an over-the-air communication.

17. A method comprising the steps of:
receiving at a target base station, notification that a mobile station desires to hand off to the target base station, wherein the notification is generated at a source base station and comprises a first nonce generated at the mobile station;
generating a second nonce;
providing the second nonce to the mobile station; and
generating the session key based on the first and the second nonce.

18. The method of claim 17 wherein the step of generating the second nonce comprises the step of generating a random number.

19. The method of claim 17 wherein the step of generating the second nonce comprises the step of generating a nonce based on a time stamp, a sequence number, or a current frame number.

20. The method of claim 17 wherein the step of generating the session key comprises the step of generating the session key as a function of a pair-wise master key (PMK), a Base Station Identifier, a Mobile station identifier, the first nonce, and the second nonce.

21. The method of claim 17 further comprising the step of:
encrypting communications with the mobile station with the session key.

22. The method of claim 17 wherein the step of providing the second nonce to the mobile station comprises the step of providing the second nonce to a source base station, causing the source base station to forward the second nonce to the mobile station.
